(19) United States
(12) Patent Application Publication
(10) Pub. No.: US 2006/0002826 A1
(43) Pub. Date: Jan. 5, 2006

(54) Sampling apparatus

(76) Inventors: Martin Alan Lee, Salisbury (GB); David James Squirrell, Salisbury (GB); Michael Edward Best, Lockerley (GB); Brian Thomas Croft, Lockerley (GB)

Correspondence Address: JOHN S. PRATT, ESQ;KILPATRICK STOCKTON, LLP, 1100 PEACHTREE STREET, ATLANTA, GA, 30309, US

(21) Appl. No.: 10/529,608

(22) PCT Filed: Oct. 2, 2003
(86) PCT No.: PCT/GB03/04291

§ 371 Date: Mar. 30, 2005

(30) Foreign Application Priority Data
Oct. 3, 2002 (GB) 0222855.9

(51) Int. Cl. B01L 3/00

(52) U.S. Cl. 422/102

(57) ABSTRACT

This invention relates to a method and associated apparatus for isolating a known volume of sample solution comprising: (i) taking an apparatus comprising a first chamber with a sealing means, a second chamber, wherein said first and said second chamber are connected via a duct and collecting the sample solution into the first chamber of the apparatus; and (ii) pumping a pre-determined known volume of the sample solution into the second chamber of the apparatus. The sample solution of the present invention preferably comprises a nucleic acid target material. This invention also relates to a single integrated apparatus and a kit capable of performing the same.

This invention relates to a method and associated apparatus for accurately isolating a known volume of a sample solution. More particularly this invention relates to a method and associated apparatus for use in a clinical environment for isolating a known volume of a sample solution comprising a nucleic acid target material. Even more particularly this invention relates to a method and associated apparatus for isolating a known volume of a sample solution comprising a nucleic acid target material wherein the sample is initially presented either as a solution, or on a swab.

Identification of biological material including micro-organisms such as bacteria and viruses, and other genetic material and nucleic acids, is currently an area of important development because it allows for, among other things, the diagnosis of disease states. Rapid and accurate diagnosis of diseases has important social and economic consequences. These include that the correct treatment can be quickly administered to a patient increasing the likelihood of success, reducing patient anxiety, and reducing the risk of the spread of infection. Although there are many examples of disease states where it would be useful to quickly and rapidly positively identify infection, one particular example is the identification of the bacterial sexually transmitted disease (STD) Chlamydia trachoinatis. Diagnosis of this STD is a current focus of health care professionals globally since, in the USA alone, it is the most prevalent transmitted STD resulting in more than 4 million new cases each year and also because, if left untreated in female patients, it can lead to to costly sequelae such as pelvic inflammatory disease, ectopic pregnancy and, ultimately, to infertility.

One of the best known techniques for the identification of genetic material and nucleic acids is to first replicate the material, thereby generating sufficient material for positive identification. The polymerase chain reaction (PCR) is a commonly used method for replicating such material that has several advantages including that it is sensitive and selective. This means that is can be used to accurately identify a wide range of different nucleic acid targets from only a small initial sample. Such a method is ideal for use to positively identify nucleic acids in a wide variety of different biological samples. However, when trying to expand the use of PCR for general day to day rapid diagnosis, there are several problems to consider. These include that prior to the PCR amplification the sample needs to be purified and concentrated using complex techniques and sometimes hazardous reagents, which to date is conducted only in specialist laboratories. This results in a slow, resource intensive and expensive process which is also subject to possible sample cross contamination. There remains a need to develop a means whereby in a non-laboratory environment, a nucleic acid target can be isolated from a wide variety of different types for subsequent replication by PCR in order to improve response times, to free skilled labour from repetitive tasks and to reduce costs.

The first step in purifying a nucleic acid target from a sample for subsequent replication by PCR, is to obtain an accurately dispensed pre-determined known volume of a sample in solution comprising the target material. When considering the development of a means for use outside of the laboratory environment, there are several problems associated even with this first apparently simple step. These include that different sample types (eg blood, urine swab) require different processing, accurate measurement of a known volume of a sample solution requires the use of additional equipment including pipettes or measuring cylinders which are non-standard outside of a laboratory and the use of which requires special training, transfer of the sample from one piece of equipment to another can lead to sample cross contamination and may also lead to contamination and infection of the user, and that if the sample solution volume is not measured sufficiently accurately the level of nucleic acids material obtained may be so low as to result in a false negative result.

There is a need to develop a method and associated apparatus whereby an operator with little or no laboratory training, for example a health care practitioner, can obtain a sample, for example a patient sample, for example a urine sample, manipulate it if necessary to obtain a solution, and also easily and accurately measure a pre-determined known volume of that solution without risk of self-infection. Preferably such a method and apparatus should be sufficiently flexible such that it can be used with equal effect regardless of the form of the sample. Furthermore, such a method and apparatus, should have sufficient consistency in delivery of the pre-determined volume of material to prevent the failure of any later PCR assay. In addition any associated apparatus should be able to be produced in a cost-effective manner and to be disposable such that different samples can be prepared and measured rapidly without the possibility of cross contamination or the need to sterilise large amounts of equipment.

A prior art search has identified bottle designs that can be used to dispense a volume of liquid from the stored bulk. Examples of such disclosures include EP 0 010 965 and EP 0 060 060. Such bottles provide developments in the storage and dispensing of toxic household and agricultural liquids, for example liquid fertilisers. The problem remains however as to how to develop a method and associated apparatus to first collect a sample, optionally comprising a nucleic acid target and then to solvate the sample if necessary and then accurately isolate a known volume of that sample solution. Such a method and apparatus should be able to be used with equal effect with a wide variety of different clinical sample types for example urine samples, swab samples and blood samples. The problem also remains as to how to achieve this in a non-laboratory environment by a means that can be accurately and consistently operated by a user with little or no laboratory experience.

A method, and associated apparatus, has now been developed which addresses the above problems. The method involves the use of an apparatus comprising a first chamber with an opening, a second chamber with an opening, wherein the first and second chambers are connected to each other via a duct, and wherein the first chamber, and optionally the second chamber, comprise a sealing means. The sample solution optionally comprising a nucleic acid target material, for example urine, is collected, optionally using a funnel, directly into the first chamber of the apparatus. The first chamber is then sealed using the sealing means. By squeezing the body of the first chamber a volume of sample solution can be pumped, via the duct, into the second chamber of the apparatus. The displaced air from the second chamber is able to escape via the opening of the second chamber. By positioning the duct at the base of the first chamber, the sample solution can be readily pumped from the first chamber to the second chamber. The positioning of the duct within the second chamber regulates the volume of sample that can be pumped from the first chamber to the second chamber with the result that only a known and pre-determined volume of sample solution will be retained in the second chamber. When the pumping of solution is complete, any excess solution that has passed into the second chamber will immediately drain through the duct and back into the first chamber. Such a design allows for the accurate collection of a pre-determined volume of sample solution in the second chamber from an unknown volume of bulk sample solution in the first chamber.

The method has also been developed such that the same apparatus can be used to obtain a pre-determined known volume of solution comprising a nucleic acid target material when the operator is presented with a small amount of a viscous liquid or solid sample material, for example a blood sample or a patient swab. In this case the sample is placed directly into the second chamber of the apparatus. The chosen solvent for dissolving or diluting the sample is then placed into the first chamber of the apparatus. By operating the apparatus as described above a pre-determined known volume of solvent can be accurately pumped from the first chamber to the second chamber and used to dissolve or dilute the sample.

Once the known volume of sample solution has been collected in the second chamber, it can be further manipulated optionally in situ by, for example, pre-dosing the second chamber with a reagent bead. Alternatively it can be dispensed directly into a further receptacle for additional processing by first ensuring that the first chamber of the apparatus is tightly sealed and then inverting the apparatus. As the apparatus is inverted two mechanisms operate to prevent additional bulk solution flowing from the first chamber into the second chamber and then subsequently into the further receptacle. The first is that once the apparatus is inverted, any air in the first chamber moves towards what was the bottom of that chamber and hence covers the entrance to the duct preventing flow of further bulk. Secondly, as the solution leaves the second chamber, the displacing air enters the second chamber and flows into the duct thus preventing further liquid pouring from the first chamber along the duct. The result is that only the isolated and accurately measured volume of sample solution comprising the target material is dispensed from the apparatus thus achieving the desired result.

The method and associated apparatus of the present invention have several advantages. These include that they can be used by an operator in a non-laboratory environment to obtain a nucleic acid target material solubilised in a known volume of solvent. Furthermore the method and apparatus have a high level of accuracy so that the volume of sample solution obtained is highly consistent. This results in a reduced margin of error in any subsequent sample manipulation, for example PCR, thus improving the success of the overall diagnostic technique. Other advantages include that personnel with little or no practical laboratory training can readily operate the method and apparatus thus freeing skilled workers from routine work and reducing the cost. Furthermore, the method can be readily adapted in the clinic for use with a wide variety of different sample types, it is fast and that the apparatus can cheaply be manufactured and can therefore be disposable reducing the likelihood of cross contamination between samples. In addition, the apparatus can be dosed with reagents or designed to integrate with further receptacles, such that the known volume of isolated sample solution can be transferred and further manipulated for example nucleic acid material can be further purified, concentrated and amplified.

It is an object of the present invention to design a method and related apparatus to enable the collection of a sample, optionally comprising a nucleic acid target material, and the accurate isolation of pre-determined volume of said sample in solution. It is further object of this invention that such a method, and associated apparatus, are flexible enough to be used to equal effect with a wide variety of different sample types. It is another object of this invention that such a method, and associated apparatus, are easy to use in a non-laboratory environment, such as a clinic, by a user with little or no scientific training whilst simultaneously reducing any chance of user enforced error and cross contamination of samples. It is yet another object of this invention to design such a method and apparatus so that the isolated sample can be further manipulated if required, for example purified or concentrated. These, and other objects of this invention, will become apparent in light of the following disclosure.

### SUMMARY OF THE INVENTION

According to a first aspect this invention relates to a method for isolating a known volume of sample solution comprising:
(i) taking an apparatus comprising a first chamber with a sealing means, a second chamber, wherein said first and said second chamber are connected via a duct and collecting the sample solution into the first chamber of the apparatus; and
(ii) pumping a pre-determined known volume of the sample solution into the second chamber of the apparatus.

According to a second aspect this invention relates to method for isolating a known volume of sample solution comprising:
(i) taking an apparatus comprising a first chamber with a sealing means, a second chamber, and wherein said first and said second chamber are connected via a duct and placing a sample into the second chamber of the apparatus;
(ii) placing a solvent suitable for dissolving or diluting said sample into the first chamber of the apparatus;
(iii) pumping a pre-determined known volume of said solvent from the first chamber into the second chamber of the apparatus; and
(iv) allowing said solvent to dissolve or dilute said sample.

According to a third aspect this invention relates to an apparatus for isolating a known volume of sample solution comprising:
(i) a first chamber with an opening;
(ii) a second chamber with an opening;
(iii) a means for sealing said first chamber;
(iv) a means for sealing said second chamber said means having an inverted conical shape; and
   wherein the first chamber is connected to the second chamber by a duct.

According to a fourth aspect this invention relates to an apparatus for isolating a known volume of sample solution comprising:
(i) a first chamber with an opening;
(ii) a second chamber with an opening said chamber additionally comprising a functional reagent;
(iii) a means for sealing said first chamber; and
   wherein the first chamber is connected to the second chamber by a duct.

According to a fifth aspect this invention relates to a kit for isolating a known volume of sample solution comprising:
(i) an apparatus comprising:
   (a) a first chamber with an opening;
   (b) a second chamber with an opening;
   (c) a means for sealing said first chamber; and
wherein the first chamber is connected to the second chamber by a duct, and
(ii) a functional reagent.

### DETAILED DESCRIPTION OF THE INVENTION

All publications cited herein are hereby incorporated by reference in their entirety, unless otherwise indicated.

The elements of the apparatus are described in more detail below.

This invention relates to a method for isolating a known volume of sample solution comprising:
(i) taking an apparatus comprising a first chamber with a sealing means, a second chamber, wherein said first and said second chamber are connected via a duct and collecting the sample solution into the first chamber of the apparatus; and
(ii) pumping a pre-determined known volume of the sample solution into the second chamber of the apparatus.

This method allows the user to collect an unknown volume of a liquid sample, optionally comprising a target material, place the sample into the first chamber of the apparatus and then use the apparatus to accurately isolate a pre-determined volume of the sample into a second chamber in the apparatus. This method can be used to collect any one of a wide variety of liquid samples including solutions. Preferably the sample is a solution. This method is ideal for use to isolate a pre-determined volume of a sample solution comprising a target material, particularly a nucleic acid target material. Examples of sample solutions that might comprise such a target include a patient urine sample, or a sample of water taken from the environment.

Ideally the liquid sample is collected directly into the first chamber of the apparatus which obviates the need for the use of any further sample collection equipment. It is possible to optionally integrate a cone or funnel temporarily with the first chamber of the apparatus to make it easier to collect the sample into the apparatus without any spillage. This is especially true when collecting a urine sample directly from a patient into the apparatus. Such cones should be designed to fit securely into the opening of the first chamber so that no sample is lost due to leakage.

The apparatus of the present invention comprises a first chamber with an opening, a second chamber with an opening and a duct that connects the first chamber to the second chamber. It is preferred that, when the apparatus is in the up-right position that the duct extends upwardly externally alongside the apparatus wall from an inlet in the bottom of the first chamber to an inlet in the second chamber. It is preferred that the first and second chamber and the duct are integrated into a single apparatus. Overall the apparatus is designed such that a bulk volume of liquid can be collected into the first chamber, the first chamber is then sealed, and by squeezing the body of the first chamber a known aliquot of this liquid can be pumped from the first chamber into the second chamber. It is preferred that the duct exits the first chamber from the base of the chamber such that, when the apparatus is held in an up-right position, even if the first chamber comprises only a low volume of liquid it is still possible to pump an aliquot of this liquid into the second chamber via the duct. This ensures that the transfer of air between the two chambers by the pumping action is minimised thus ensuring that the volume of liquid pumped into the second chamber is as consistent as possible. The volume of sample liquid that can be pumped into the second chamber is determined by two factors—the volume of the second chamber itself and the positioning of the entrance of the duct into the second chamber. The liquid from the first chamber is pumped into the second chamber via the duct. When the apparatus is held in the upright position, if the fill volume of the second chamber is in line with or exceeds the entrance of the duct, excess liquid will drain out of the chamber back into the duct and back into the first chamber, until the level of liquid in the second chamber is below the entrance of the duct. As such the positioning of the duct is of critical importance in designing the apparatus such that the volume of the second chamber beneath the opening of the duct is equivalent to the volume of liquid that the apparatus is designed to isolate.

The apparatus of the present invention can be designed to have several different sizes and shapes that will depend upon the specific desired use. However, when used to collect and isolate a predetermined volume of sample solution comprising a nucleic acid target material it is preferred that the first chamber of the apparatus has a volume of from about 1 ml to about 500 ml, preferably of from about 10 ml to about 100 ml and more preferably of from about 20 ml to about 50 ml. It is preferred that the second chamber has a volume of from about 1 ml to about 100 ml, preferably of from about 2 ml to about 50 ml and more preferably of from about 5 ml to about 30 ml. It is preferred that the duct has a volume of from about 0.1 ml to about 5 ml, preferably from about 1 ml to about 3 ml. It is preferred that the volume of sample solution to be isolated in the second chamber is pre-determined to be from about 1 ml to about 50 ml, preferably from about 2 ml to about 30 ml and more preferably from about 5 ml to about 20 ml in the second chamber. In addition it is preferred that the volume of sample solution isolated in the second chamber is accurate to within about 10%, preferably less than about 5% and more preferably less than about 1% of said pre-determined volume.

It is ideal if the apparatus is designed to have dimensions such that it can be easily held in one hand. It is preferred if the apparatus has a height of from about 50 mm to about 200 mm, preferably of from about 80 mm to about 120 mm. Similarly it is preferred if the apparatus has a width of from about 20 mm to about 150 mm, preferably from about 50 mm to about 100 mm. Finally it is preferred if the duct has an internal diameter of from about 1 mm to about 10 mm, preferably of from about 2 mm to about 6 mm. The internal diameter of the duct may vary depending on the viscosity of the liquid that is being pumped from the first chamber of the apparatus to the second chamber of the apparatus.

In order to be able to use the apparatus to pump liquid from the first chamber to the second chamber, the first chamber of the apparatus should be made of a material that is deformable. This allows the first chamber to be squeezed once or more often either manually or by machine. It is preferred that the chamber is squeezed manually so that it can be easily operated in a non-laboratory environment without the need for additional equipment. In order to reduce the complexity of the apparatus it is preferred that the whole apparatus is made of the same material. Furthermore it is preferred that the apparatus is made of moulded resiliently deformable plastics material. This is because such material can be easily and cheaply manufactured and is disposable. Preferably the apparatus is formed of a thermoplastic material such as polyethylene or polypropylene or butadiene-styrene copolymer or mixtures thereof. Furthermore it is preferred that the apparatus is manufactured using blow moulding techniques. It is preferred that the apparatus is disposable.

The apparatus comprises a means for sealing the first chamber. It is preferred that the sealing means is designed such that it can be easily removed and replaced or loosened or tightened. One example of a sealing means that works well for the apparatus of the present invention is a screw cap. The sealing means can be made of any one of a wide variety of designs and materials but it is preferred that they are also made of plastic material since this is cheap to produce, can be readily coloured to aid use of the apparatus and is disposable.

The second chamber of the apparatus may optionally comprise a sealing means. Such a means can be used to maintain a sterile environment within the second chamber of the apparatus prior to using the chamber to isolate the known volume of sample liquid. As before, many different types of sealing means are suitable. Again it is preferred that the sealing means is a screw cap. This has the advantage that, by loosening the screw cap, it is possible to release the seal sufficiently to allow displaced air to be released thus allowing the apparatus to still be used to pump liquid from the first chamber to the second chamber whilst at the same time maintaining a cover over the second chamber which prevents liquid from splashing out of the chamber and impurities entering the chamber.

The apparatus can be transparent or translucent. The first chamber of the apparatus and the second chamber of the apparatus can optionally be marked with graduations to indicate when the correct level of sample solution has been collected or isolated. When the apparatus is used to collect a urine sample it is preferred that the first chamber of the apparatus is marked with a graduation to indicate when about 30 ml of urine has been collected. Advantageously the means for sealing the first chamber and the means for sealing the second chamber are colour coded with different colours. This can be used for help direct the unskilled user as to the correct use of the apparatus. This colour coding can be tied in with colour coded apparatus which may integrate with either the first chamber or the second chamber of the apparatus such that it is easier for the user to integrate such equipment with the correct chamber.

This invention also relates to the use of any apparatus comprising a first chamber, a second chamber, a means for sealing said first chamber and wherein said first chamber and said second chamber are connected by a duct for the collection of a sample solution, preferably a sample solution comprise a nucleic acid target material and the isolation of a known volume of sample solution in said second chamber.

This invention also relates to a method for isolating a known volume of sample solution comprising:
(i) taking an apparatus comprising a first chamber with a sealing means, a second chamber, and wherein said first and said second chamber are connected via a duct and placing a sample into the second chamber of the apparatus;
(ii) placing a solvent suitable for dissolving or diluting said sample into the first chamber of the apparatus;
(iii) pumping a pre-determined known volume of said solvent from the first chamber into the second chamber of the apparatus; and
(iv) allowing said solvent to dissolve or dilute said sample.

This method allows the user to collect a solid or highly viscous liquid sample, preferably comprising a target material, more preferably a nucleic acid target material, and to dissolve or dilute the sample in an accurately known volume of chosen solvent. The sample is placed directly into the second chamber of the apparatus. The first chamber of the apparatus is then filled with the desired solvent. A known volume of this solvent can then be accurately dispensed into the second chamber of the apparatus by pumping as previously described. Once in the second chamber the solvent is able to dissolve or dilute the sample material. Examples of samples for which this method is useful include blood samples, samples obtained from a patient or the environment using a swab or a solid sample, for example a soil sample. A wide variety of different solvents can be used, including aqueous and non-aqueous solvents. It is preferred that the solvent is water or an aqueous solution. When used in this mode it is advantageous for the apparatus to comprise a sealing means for the second chamber. This is because, once the solvent has been pumped into the second chamber it may be necessary to agitate or shake the apparatus to ensure that the sample is fully dissolved or diluted. If the apparatus is to be used with a sample that is collected on a swab it is preferred that the means for sealing the second chamber is shaped like an inverted cone. This has the advantage that the means for sealing the second chamber can be sealed even when the second chamber still contains a sample swab on a stick. The apparatus for use in this method may advantageously comprise one or more of the features of such an apparatus as previously described herein. Any apparatus designed to be used with such a method is preferably designed such that the volume of solvent to be isolated in the second chamber is pre-determined to be from about 1 ml to about 50 ml, preferably from about 2 ml to about 30 ml and more preferably from about 5 ml to about 20 ml in the second chamber. As previously, the volume of solvent isolated in the second chamber is preferably accurate to within about 10%, preferably less than about 5% and more preferably less than about 1% of said pre-determined volume.

This invention also relates to an apparatus for isolating a known volume of sample solution comprising:
(i) a first chamber with an opening;
(ii) a second chamber with an opening;
(iii) a means for sealing said first chamber;
(iv) a means for sealing said second chamber said means having an inverted conical shape; and
   wherein the first chamber is connected to the second chamber by a duct.

This aspect of the invention relates to a single apparatus that can be used with equal effect to collect a wide variety of different liquid or solid sample types and isolate a known volume of the sample, either as collected or dissolved or diluted as required. Preferably the sample comprises a nucleic acid target material. Such an apparatus therefore allows for simple and accurate isolation in a non-laboratory environment of a suitable quantity of the target material in preparation for further purification and replication by PCR. Such an apparatus may advantageously comprise one or more of the features as previously described herein.

This invention also relates to an apparatus for isolating a known volume of sample solution comprising:
(i) a first chamber with an opening;
(ii) a second chamber with an opening said chamber additionally comprising a functional reagent;
(iii) a means for sealing said first chamber; and
   wherein the first chamber is connected to the second chamber by a duct.

The object of having a functional reagent in the second chamber of the apparatus is such that it can readily interact with the sample in the second chamber, and preferably with the known aliquot of sample solution that is isolated in the second chamber. Whilst a wide variety of different functional reagents can be used, the preferred use of the apparatus is to prepare a sample comprising a nucleic acid target for further manipulation by PCR. As such it is preferred that the functional reagent is a bead comprising a material capable of lysing any cells including bacteria within the sample which may comprise some or part of the nucleic acid target. Such a material includes a bead comprising chaotrophic salts. The functional reagent could also comprise further secondary agents for example a control nucleic acid sequence that can act as a means for normalising the efficiency of the PCR. Another example of a suitable functional reagent is intact bacteriophage Lambda that is also useful when preparing a sample for later use in PCR. Other examples of chemical reagents include lyophilised enzymes or chromogens. However, there is no reason to limit the functional reagent to a chemical agent. The functional reagent could optionally be a physical means of interacting with the sample for example a magnetic stirrer bead, a heating means or magnetic beads coated with antibodies. The former are useful for agitating material in the second chamber which can help with dissolving or diluting such material in a suitable solvent which is especially important when the material is thick or contains particles or puss, and the latter are useful for removing specific types of bacteria. The functional reagent can optionally be restrained within the second chamber by a grid or filter to prevent the reagent accidentally falling out of the apparatus. Such an apparatus may advantageously comprise one or more of the features as previously described herein. This invention also relates to a method of use for an apparatus as outlined herein comprising a functional reagent in the second chamber.

This invention also relates to a kit for isolating a known volume of sample solution comprising a target material comprising:
(i) an apparatus comprising:
   (a) a first chamber with an opening;
   (b) a second chamber with an opening;
   (c) a means for sealing said first chamber; and
wherein the first chamber is connected to the second chamber by a duct, and
(ii) a functional reagent.

The advantage of such a kit is that a standard dual chamber collection and isolation apparatus as described herein can be supplied with one or more of a wide variety of different functional reagents depending on the intended use of the apparatus. Such an apparatus may advantageously comprise one or more of the features as previously described herein.

The apparatus described herein can also optionally be designed such that it can integrate with further supplementary apparatus. Such integration should preferably be in a sealed manner such that matter can be transferred from one apparatus to the other without the risk of spillage that could cause several problems including a risk of infection to the user. The apparatus could be designed to integrate using a wide variety of different means, including a quick fit seal, a screw fitting or a simple push fit, or other means. If the apparatus of the present invention is moulded from plastic then such integration means can be integrated easily into the shape of the parent apparatus. This integration will further simplify the use of the apparatus in the clinic for staff with little or no scientific training. As mentioned previously, one example of a supplementary apparatus includes a funnel adapted to integrate with the opening of the first chamber of the apparatus described herein which obviates the need to use a further piece of apparatus to collect a liquid sample, or dispense a bulk solvent prior to transfer to the first chamber. A second example of a further apparatus is a purification device that could optionally integrate with the opening of the second chamber of the apparatus. In the case of isolation of a known volume of a sample solution comprising a nucleic acid target for subsequent PCR, it would be ideal if the known volume of sample solution could be dispensed directly into such a purification apparatus. Once in the apparatus the sample should be sequentially washed and concentrated with a concentration device such as silica or glass fibre filters ready for nucleic acid amplification using PCR. In this instance it is particularly important that the purification device is able to integrate effectively with the second chamber of the apparatus such that none of the accurately dispensed sample solution is lost as it is transferred from the second chamber to the purification device.

If the apparatus is designed to further integrate with a supplementary apparatus, then optionally the opening to the first chamber, or the second chamber or both chambers may comprise a filter membrane. This is particularly important in the second chamber where an isolated sample solution is transferred to a supplementary apparatus for further processing. Such a filter ensures that unwanted particulate matter in the sample do not block and clog the latter apparatus. If the apparatus is used for isolating a sample from urine or swab in a known volume of solution it is useful to use a filter with a mesh size of in the region of about 500 μm to ensure that any puss or other particulate matter present in the original sample is not transferred to the supplementary apparatus. Furthermore, if the apparatus is designed to integrate with further apparatus it is likely important that the user attaches the further apparatus to the correct chamber. As such it may be useful to colour code one or more of the chamber openings and further apparatus to ease use and minimise error. In addition the integration means can be designed such that it is not possible to attach the further apparatus to the wrong chamber for example by using reverse thread screw fittings and the like.

### FIGURES

This invention will now be described by reference to the following drawings in which;

FIG. 1 shows an apparatus of the present invention;

FIG. 2 shows a cross section of the apparatus of the present invention when being used to collect a sample solution comprising a target material and to isolate a known volume of said solution; and

FIG. 3 shows a cross section of apparatus of the present invention when being used to collect a solid or viscous sample comprising a target material and to dissolve or dilute said sample in a suitable solvent.

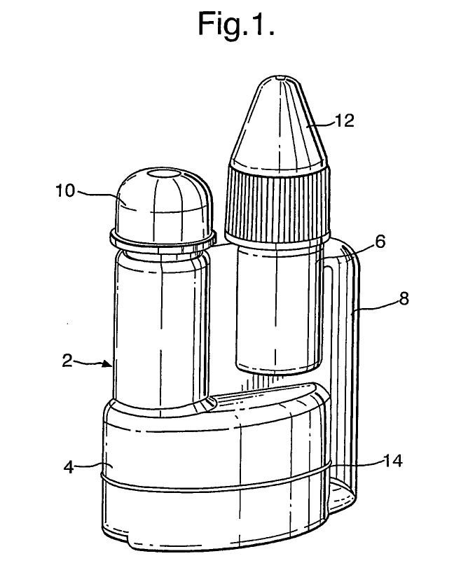

FIG. 1 shows the apparatus of the present invention 2 comprising a first chamber 4 and a second chamber 6. A duct 8 connects the first chamber 4 to the second chamber 6. The first chamber comprises a sealing means 10. The second chamber also comprises a sealing means 12 that has an inverted conical shape. The sealing means 10 and 12 attach to their respective chamber openings by means of a screw thread (not shown). The first chamber comprises a graduation 14 that can be used as a filling guide. The bottle 2, comprising the first chamber 4, the second chamber 6 and the duct 8 is manufactured as a single article.

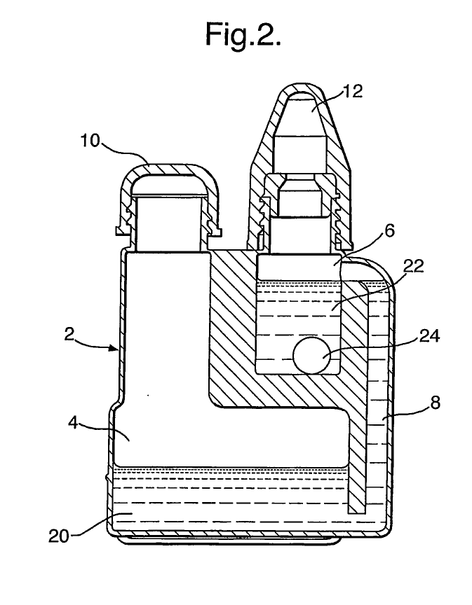

FIG. 2 shows a cross section of the apparatus of the present invention 2 when being used to collect a sample solution 20 comprising a target material (not shown) and to isolate a pre-determined known volume of said solution 22. The apparatus comprises a first chamber 2 into which the sample solution 20 is collected. The apparatus also comprises a second chamber 6 that is connected to the first chamber 4 by a duct 8. The first chamber comprises a sealing means 10 and the second chamber comprises a sealing means 12. Once the sample solution has been placed in the first chamber 4 the first chamber is sealed using a sealing means 10. The sealing means for the second chamber 12 is then loosened sufficiently so that air can be displaced from the second chamber 6. The first chamber 4 is then squeezed. This pumps the sample solution 20 from the first chamber 4, via the duct 8 and into the second chamber 6. The volume of isolated sample solution 22 in the second chamber 6 is controlled by the position of the duct 8 in the second chamber 6. If the second chamber 6 becomes over filled, excess sample solution 20 will drain via the duct 8 back into the first chamber 4. FIG. 2 shows the second chamber 6 comprising an optional functional reagent 24.

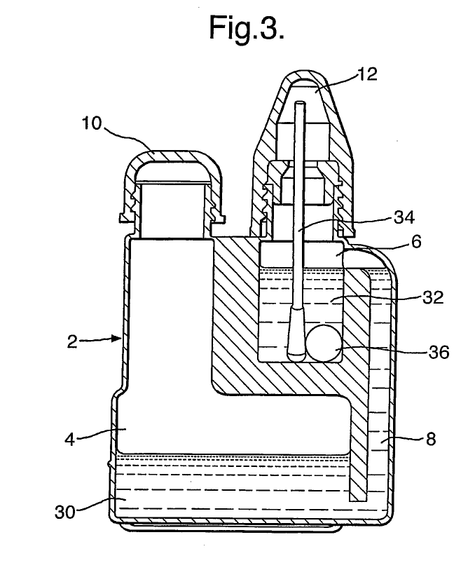

FIG. 3 shows a cross section of apparatus of the present invention 2 when being used to collect a solid or viscous sample comprising a target material (not shown) and to dissolve or dilute said sample in a suitable solvent 30 thereby isolating a known volume of solution containing the sample 32. The solid or viscous sample is collected on a swab 34 and placed into the second chamber 6 of the apparatus 2. The second chamber is sealed using a sealing means 12. By using a sealing means 12 with an inverted conical shape it is possible to seal the second chamber 6 with the sample swab 34 in situ. A suitable solvent 30 for diluting or dissolving the sample is placed into the first chamber 4. The first chamber 4 is then sealed using sealing means 10. Sealing means 12 is loosened sufficiently so that air can flow out of the second chamber 6. The first chamber 4 is then squeezed. This pumps the solvent 30 from the first chamber 4, via the duct 8 and into the second chamber 6. As before the volume of solvent 30 that is isolated in the second chamber 8 is controlled by the position of the duct 8 in the second chamber 6. The solvent 30 then dissolves or dilutes the sample such that the second chamber 6 comprises an isolated known volume of sample solution 32. The figure shows the second chamber 6 optionally comprising a functional reagent 36. In this instance the functional reagent 36 may be a stirrer bead to allow for improved solution of the sample.

1. A method for isolating a known volume of sample solution comprising:
(i) taking an apparatus comprising a first chamber with a sealing means, a second chamber, wherein said first and said second chamber are connected via a duct and collecting the sample solution into the first chamber of the apparatus; and
(ii) pumping a pre-determined known volume of the sample solution into the second chamber of the apparatus.

2. A method according to claim 1 wherein the sample solution comprises a target material, preferably a nucleic acid target material.

3. A method according to any of claim 1 or 2 wherein, when the apparatus is upright, the duct extends upwardly externally from an inlet in the bottom of the first chamber to an inlet in the top of the second chamber.

4. A method according to any of claims 1 to 3 wherein the apparatus is manufactured from a moulded resiliently deformable plastic.

5. A method according to any of claims 1 to 4 wherein the first chamber of the apparatus has a volume of from about 1 ml to about 500 ml, preferably of from about 10 ml to about 100 ml and more preferably of from about 20 ml to about 50 ml.

6. A method according to any of claims 1 to 5 wherein the second chamber of the apparatus has a volume of from about 1 ml to about 100 ml, preferably of from about 2 ml to about 50 ml and more preferably of from about 5 ml to about 30 ml.

7. A method according to any of claims 1 to 6 wherein the duct has a volume of from about 0.1 ml to about 5 ml, preferably from about 1 ml to about 3 ml.

8. A method according to any of claims 1 to 7 wherein the volume of sample solution to be isolated in the second chamber is pre-determined to be from about 1 ml to about 50 ml, preferably from about 2 ml to about 30 ml and more preferably from about 5 ml to about 20 ml in the second chamber.

9. A method according to any of claims 1 to 8 wherein the volume of sample solution isolated in the second chamber is accurate to within about 10%, preferably less than about 5% and more preferably less than about 1% of said pre-determined volume.

10. A method according to any of claims 1 to 9 wherein the first chamber of the apparatus integrates with a funnel.

11. A method according to any of claims 1 to 10 wherein the apparatus is disposable.

12. A method for isolating a known volume of sample solution comprising:
(i) taking an apparatus comprising a first chamber with a sealing means, a second chamber, and wherein said first and said second chamber are connected via a duct and placing a sample into the second chamber of the apparatus;
(ii) placing a solvent suitable for dissolving or diluting said sample into the first chamber of the apparatus;
(iii) pumping a pre-determined known volume of said solvent from the first chamber into the second chamber of the apparatus; and
(iv) allowing said solvent to dissolve or dilute said sample.

13. A method according to claim 12 wherein the sample is a solid or viscous liquid sample.

14. An apparatus for isolating a known volume of sample solution comprising:
(i) a first chamber with an opening;
(ii) a second chamber with an opening;
(iii) a means for sealing said first chamber;
(iv) a means for sealing said second chamber said means having an inverted conical shape; and
wherein the first chamber is connected to the second chamber by a duct.

15. An apparatus for isolating a known volume of sample solution comprising:
(i) a first chamber with an opening;
(ii) a second chamber with an opening said chamber additionally comprising a functional reagent;
(iii) a means for sealing said first chamber; and
wherein the first chamber is connected to the second chamber by a duct.

16. An apparatus according to claim 15 wherein the functional reagent is a pre-dosed reagent bead capable of lysing bacteria.

17. An apparatus according to claim 16 wherein the functional reagent comprises chaotrophic salts.

18. An apparatus according to claim 15 or 16 wherein the functional reagent comprises a control nucleic acid sequence.

19. A kit for isolating a known volume of sample solution comprising:
(i) an apparatus comprising:
(a) a first chamber with an opening;
(b) a second chamber with an opening;
(c) a means for sealing said first chamber; and
wherein the first chamber is connected to the second chamber by a duct, and
(ii) a functional reagent.
